(19) United States
(12) Patent Application Publication
(10) Pub. No.: US 2019/0025443 A1
(43) Pub. Date: Jan. 24, 2019

(54) DETECTOR WITH RADIOPAQUE SHEET BATTERY

(71) Applicant: CARESTREAM HEALTH, INC., Rochester, NY (US)

(72) Inventor: Todd R. MINNIGH, Pittsford, NY (US)

(21) Appl. No.: 16/034,744

(22) Filed: Jul. 13, 2018

Related U.S. Application Data
(60) Provisional application No. 62/534,753, filed on Jul. 20, 2017.

(51) Int. Cl. G01T 1/203; H01M 4/13; H01M 10/42; H01M 10/48; H01M 10/0525

(52) U.S. Cl. CPC G01T 1/2033; H01M 4/13; H01M 10/0525; H01M 10/48; H01M 10/4285

(57) ABSTRACT

A DR detector includes a housing enclosing a two-dimensional array of imaging sensors and a radiopaque battery in the form of a sheet configured to provide electrical power to the imaging sensors and to shield against undesired radiographic radiation. The radiopaque battery layer covers an area about the same as, or a major fraction of, a front or back surface of the DR detector.

### CROSS REFERENCE TO RELATED APPLICATIONS

This application claims priority to U.S. Patent Application Ser. No. 62/534,753, filed Jul. 20, 2017, in the name of Todd R. Minnigh, and entitled DETECTOR WITH RADIOPAQUE SHEET BATTERY, which is hereby incorporated by reference herein in its entirety.

### BACKGROUND OF THE INVENTION

The subject matter disclosed herein relates to digital radiographic (DR) detectors. In particular, to a DR detector having a planar, flexible, or curved contour, wherein the battery, capacitor or super capacitor powering the detector is in the form of a sheet serving as a thin x-ray shield having the same or similar height and/or width of the entire detector. As such, the battery may replace a lead (Pb), or other material, backscatter sheet that is typically used to provide backscatter shielding or absorption. Such a sheet battery may also be used in combination with a backscatter shield having a reduced thickness. The sheet battery disclosed herein may also be configured to break away in the event of a detector impact caused, for example, by an accidental drop of the detector.

The discussion above is merely provided for general background information and is not intended to be used as an aid in determining the scope of the claimed subject matter.

### BRIEF DESCRIPTION OF THE INVENTION

A DR detector includes a housing enclosing a two-dimensional array of imaging sensors and a radiopaque battery in the form of a sheet configured to provide electrical power to the imaging sensors and to shield against undesired radiographic radiation. The radiopaque battery layer covers an area about the same as, or a major fraction of, a front or back surface of the DR detector. An advantage that may be realized in the practice of some disclosed embodiments of the sheet battery is a reduced weight of the DR detector.

In one embodiment, a DR detector includes a housing that encloses a two-dimensional array of imaging sensors. The imaging sensors may be formed to have a front surface imaging area to face an x-ray source and a back surface area opposite the front surface imaging area. A radiopaque battery layer facing toward the back surface area of the imaging sensors provides electrical power to the imaging sensors. The radiopaque battery layer has the same or similar height and/or width of the front surface imaging area.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a perspective view of a prior art DR detector with a battery compartment;

FIG. 2 is a perspective view of an exemplary DR detector with a sheet battery of the present disclosure;

FIG. 3 is a perspective view of a DR detector in the path of an x-ray beam generating x-ray scatter;

FIG. 4 is a perspective view of an exemplary DR detector with a battery compartment undergoing an impact;

FIG. 5 is a perspective view of an exemplary DR detector with a sheet battery undergoing an impact;

FIG. 6 is another perspective view of an exemplary DR detector with a sheet battery undergoing an impact; and

FIG. 7 is a plot of a LiPo sheet battery thickness that provides equivalent x-ray attenuation as does one (1) mm of lead at different x-ray energy levels.

### DESCRIPTION OF THE INVENTION

Sheet batteries, capacitors, or super capacitors, generally referred to herein as batteries, may be manufactured with a high radio density to provide a radiopaque x-ray shield for a DR detector while also providing electrical operational power for the DR detector. Replacing all, or a portion of, existing lead shielding in the DR detector with a such a sheet battery can eliminate, or reduce, the volume of lead used, and may provide a substitute for two single purpose components, the standard block battery and lead sheet, by using one dual purpose component—an x-ray scatter shielding sheet battery.

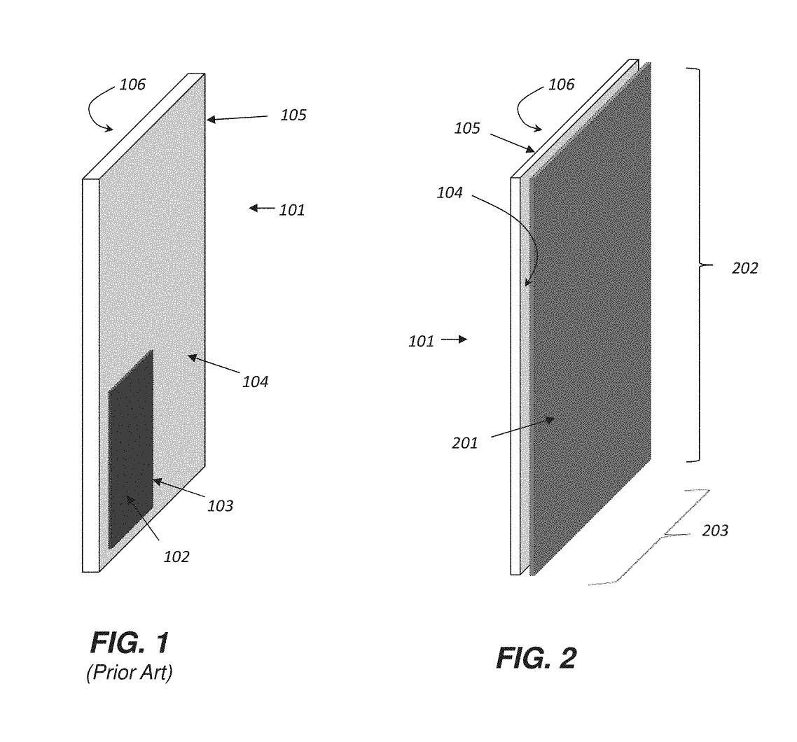

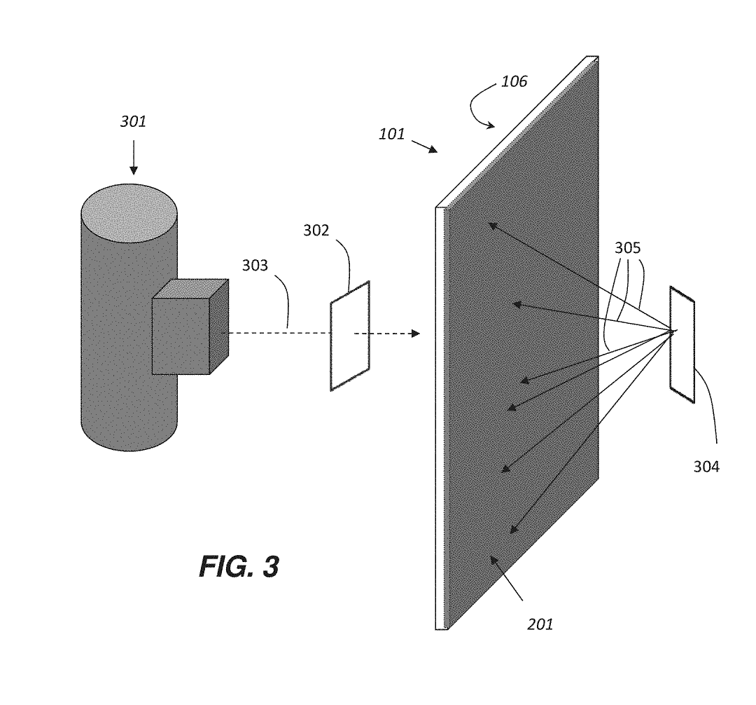

As shown in FIG. 1, a standard DR detector 101 typically includes a standard block battery 102 inserted into a battery slot 103 in a back side 104 of a housing 105 of the DR detector 101. The front side 106 of the DR detector 101 typically faces toward an x-ray source (see FIG. 3) to capture radiographic images of a radiographically exposed object using a two-dimensional array of photosensitive cells or imaging pixels. The back side 104 and the front side 106 of the DR detector 101 may be referred to herein as major surfaces of the DR detector 101. The two-dimensional array of imaging pixels (FIG. 6) are enclosed in the housing 105 of the DR detector 101 and are usually formed as one front facing layer of an imaging stack having several layers. The several layers of the imaging stack may include an array substrate, a support plate, an electronics layer and an x-ray shield layer, among others. Although a planar DR detector 101 in a form of a panel is illustrated in the figures herein, the DR detector 101 may be fabricated as a flexible DR detector that flexes about a width, length, or both major dimensions of the DR detector 101. In one embodiment, the DR detector 101 may be formed in a rigid curved contour. The present disclosure is not limited to any one of these alternative embodiments and may be used with all such DR detector embodiments.

As shown in FIG. 2, and as disclosed herein, the block battery 102 may be replaced with a larger area sheet battery 201 that is selectively sized to closely match one or both major dimensions of the DR detector panel, such as the DR detector panel's height 202 and/or width 203. Thus, a surface area of the sheet battery 201 may be sized to match an area of a major surface of the DR detector 101, or a major fraction (>50%) thereof. The sheet battery 201 may be advantageously used together with a lead x-ray shield layer to reduce the usual thickness of the lead x-ray shield layer, or to eliminate use of the lead shield layer altogether by replacing it. As an example material used to form the sheet battery 201, a lithium polymer (LiPo) battery has an x-ray attenuation factor of about 5% compared to that of lead at an x-ray energy of about 90 kV. Thus, a lead x-ray shield layer having about a 0.15 mm thickness may be effectively replaced by an approximately 3 mm thick lithium polymer sheet battery 201 to provide an equivalent x-ray attenuation property. In one embodiment, the LiPo sheet battery material may be doped with a metal, for example, iron (Fe), to increase an x-ray attenuation factor of the LiPo sheet battery. As disclosed herein, such a sheet battery 201 may be formed to match the size and curvature of a curved DR detector, such as a DR detector shaped as a partial section of a cylinder, or other curvature. The sheet battery 201 may also be formed to bend or flex to match the flexibility of a flexible DR detector. As shown in the figures herein, the sheet battery 201 is illustrated as external to the DR detector housing 105 for ease of illustration. However, it will be understood that, as a preferred non-limiting embodiment, the sheet battery 201 may be positioned, during operation of the DR detector 101, within the DR detector housing 105 between an interior surface of the back side 104 of the DR detector housing 105 and the two dimensional array of imaging pixels formed as part of an imaging stack of the DR detector 101. In one embodiment, two or more separate layers of a sheet battery 201 material may be formed proximate to each other to improve x-ray attenuation. Such multiple, separate layers of a sheet battery 201 material may include a dielectric layer therebetween or other material layers. These separate sheet battery layers may have the same thickness or different thicknesses. These different sheet battery layers may be formed from the same material or from different sheet battery materials.

FIG. 3 illustrates an exemplary shielding effect provided by the sheet battery 201 in a radiographic imaging environment. An x-ray source 301 is typically aimed at a front surface 106 of DR detector 101. An object 302 to be radiographically imaged is positioned between the x-ray source 301 and the DR detector 101. A representational central x-ray 303 of the many x-rays emitted by x-ray source 301 may propagate toward and penetrate the object 302 as well as the DR detector 101 and be reflected by a random solid object 304 causing a number of scattered x-rays 305 to propagate back toward the DR detector 101. These scattered x-rays 305 may impact the array of imaging pixels in the DR detector 101 and cause a deterioration of the radiographic image of the object 302 captured by the array of imaging pixels. The sheet battery 201 formed of sufficiently dense radiopaque material, such as a lithium polymer having a thickness between about one (1) mm up to about five (5) mm, serves to absorb or block at least some of the scattered x-rays 305 thereby preventing such scattered x-rays 305 from impacting the array of imaging pixels of DR detector 101.

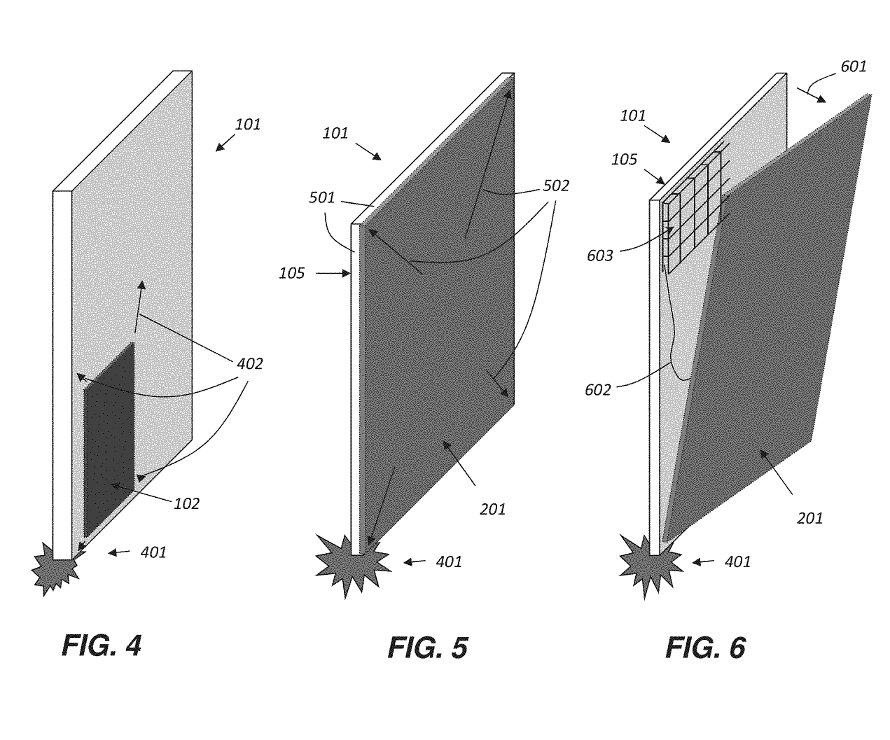

As shown in FIGS. 4-6, Absorption of a shock or impact 401, such as from an accidental drop of the DR detector 101, and weight distribution are important considerations in cassette-sized battery powered DR detectors 101 that may be advantageously addressed using a sheet battery 201. The size of the sheet battery 201 may be selected to extend as far as the edges of an adjacent layer of the imaging stack in the DR detector 101, or it may be configured to extend as far as the largest area layer in the imaging stack, which may or may not be a layer adjacent the sheet battery 201. The sheet battery 201 may be configured to contact one or more interior surfaces of the DR detector housing 105, such as interior surfaces of the edges 501 of the housing 105. In one embodiment, a sheet battery made from a LiPo material may be manufactured to desired dimensions using known printing technologies such as 3D printing. Due to its size, the sheet battery 201 transfers impact energy 502 over a larger area of the DR detector 101, as shown in the illustration of FIG. 5, as compared to the impact energy 402 of the block battery 102 as shown in FIG. 4.

As shown in FIG. 6, the sheet battery 201 may be configured to break away 601 from other components of the DR detector, such as the housing 105 or the imaging stack, during a drop impact 401, thereby transferring less impact energy from the impact to those components. The sheet battery 201 may be configured to be enclosed in a separate battery housing or in a battery housing integrated within the detector housing 105. The sheet battery 201 may be configured to be magnetically attached to an exterior surface of the detector housing 105, or to an interior surface of the detector housing 105, or it may be mechanically attached to an interior or exterior surface of the DR detector housing 105, or it may be adhesively attached thereto, or a combination thereof. As such, in these embodiments, electrical wiring 602 electrically connected to the sheet battery 201 and extending to electrical components, such as the array of imaging pixels 603, may be adapted to be electrically connected to a sheet battery 201 on an exterior side of the housing 105 of the DR detector 101 through an opening in the housing 105 of the DR detector 101 to the electrical components within the housing 105, or such wiring 602 may be entirely enclosed within the housing 105 of the DR detector 101 in other embodiments. The DR detector housing 105 may be formed as a carbon fiber tube for a lighter, sealed design because no battery cavity is needed. The materials from which the sheet battery 201 is made may be selected for both charge capacity and radiographic density. A mechanical interface between the battery and the DR detector housing may help absorb shock, because a high percentage of accidental drops will first impact one of the four corners, edges or sides of the detector. The sheet battery 201, as external or internal to the DR detector housing 105, may be used in conjunction with a capacitor, such as a super capacitor or ultra capacitor in the DR detector 101. Such a capacitor may be used as a back-up power source for the DR detector 101 in the event of a battery break away such as illustrated in FIG. 6.

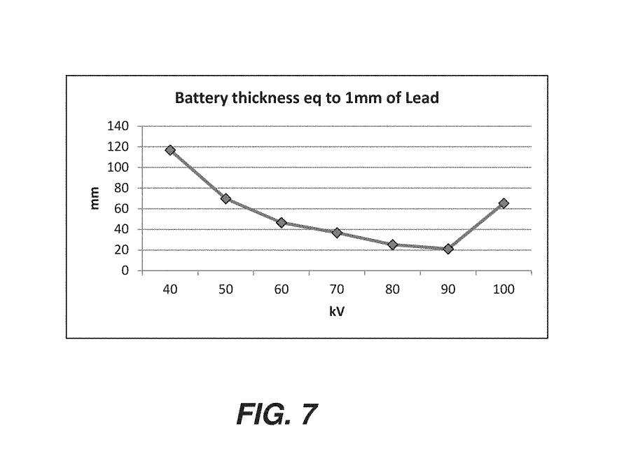

FIG. 7 show a plot of attenuation values for different thicknesses of a LiPo battery, with respect to x-ray energy levels, that are equivalent to one (1) millimeter of lead. Lithium produces little backscatter of its own in the x-ray energies within a typical diagnostic range. Batteries made with lithium or other elements provide the advantage of reducing the amount of other single purpose backscatter absorbing materials. Lead having a thickness of about 0.10 mm to about 0.20 mm may be used for x-ray backscatter shielding applications. This adds weight to the detector of about 172-853 g and functions for a single purpose. A dual purpose sheet battery may advantageously improve the weight/performance ratio in comparison to using a single purpose backscatter shield. While sheet batteries may be used alone, a combination of a thinner lead backscatter shield, such as a lead foil, and a sheet battery may produce a preferred backscatter absorption profile at a desired design thickness and weight. Instead of an x-ray shield foil formed from lead, a number of other materials may be used, such as nickel (Ni), graphite (C), iron (Fe), carbon (C) fiber, tungsten (W), tin (Sn), copper (Cu), aluminum (Al), and magnesium (Mg). The attenuation plot of FIG. 7 may be used to select materials and dimensions for desired x-ray attenuation properties of a sheet battery placed in a DR detector.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A DR detector comprising:
a housing;
a two-dimensional array of imaging sensors within the housing, the imaging sensors having a front surface imaging area configured to face an x-ray source and a back surface area opposite the front surface area; and
a first radiopaque battery layer facing toward the back surface area of the imaging sensors,
wherein the first radiopaque battery layer is configured to provide electrical power to the imaging sensors, and wherein the first radiopaque battery layer comprises an area about the same as the front surface imaging area.

2. The DR detector of claim 1, wherein the first radiopaque battery layer comprises lithium ion.

3. The DR detector of claim 2, wherein the first radiopaque battery layer comprises a thickness between about 10 mm and about 30 mm.

4. The DR detector of claim 3, wherein the detector is a lead-free detector.

5. The DR detector of claim 1, further comprising a second radiopaque battery layer facing a back surface of the imaging sensors, the second radiopaque battery layer separate from the first radiopaque battery layer.

6. The DR detector of claim 5, wherein the second radiopaque battery layer comprises a different material than the first radiopaque battery layer.

7. The DR detector of claim 6, wherein the second radiopaque battery layer comprises a different thickness than the first radiopaque battery layer.

8. The DR detector of claim 1, further comprising a foil layer having a thickness between about 0.1 mm and about 0.2 mm of lead and having an area approximately equal to the area of the first radiopaque battery layer.

9. The DR detector of claim 1, further comprising a thin backscatter layer within the detector having an area approximately equivalent to the front surface imaging area, the backscatter layer selected from the group consisting of lead, nickel, graphite, iron, carbon fiber, tungsten, tin, copper, aluminum, and magnesium.

10. A DR detector comprising:
a housing;
a two-dimensional array of imaging sensors within the housing, the imaging sensors configured to capture a radiographic image of an object exposed to radiographic energy; and
a first radiopaque sheet battery layer behind the imaging sensors relative to a source of the radiographic energy,
wherein the first radiopaque battery layer is configured to provide electrical power to the imaging sensors, and wherein the first radiopaque battery layer comprises an area about the same as a major surface area of the DR detector.

11. The DR detector of claim 10, wherein the first radiopaque battery layer comprises lithium ion.

12. The DR detector of claim 11, wherein the first radiopaque battery layer comprises a thickness between about 10 mm and about 30 mm.

13. The DR detector of claim 12, wherein the detector is a lead-free detector.

14. The DR detector of claim 10, further comprising a second radiopaque battery layer behind the imaging sensors, the second radiopaque battery layer separate from the first radiopaque battery layer.

15. The DR detector of claim 14, wherein the second radiopaque battery layer comprises a different material than the first radiopaque battery layer.

16. The DR detector of claim 15, wherein the second radiopaque battery layer comprises a different thickness than the first radiopaque battery layer.

17. The DR detector of claim 10, further comprising a foil layer having a thickness between about 0.1 mm and about 0.2 mm of lead and having an area approximately equal to the area of the first radiopaque battery layer.

18. The DR detector of claim 10, further comprising a thin backscatter layer within the detector having an area approximately equivalent to the first radiopaque battery layer, the backscatter layer selected from the group consisting of lead, nickel, graphite, iron, carbon fiber, tungsten, tin, copper, aluminum, and magnesium.

19. The DR detector of claim 10, wherein the first radiopaque battery layer is doped with iron (Fe).
